(19) United States
(12) Patent Application Publication
(10) Pub. No.: US 2024/0011538 A1
(43) Pub. Date: Jan. 11, 2024

(54) ANTI-VIBRATION MOUNT

(71) Applicant: MITSUBISHI HEAVY INDUSTRIES, LTD., Tokyo (JP)

(72) Inventor: Koichiro Ikeda, Tokyo (JP)

(73) Assignee: MITSUBISHI HEAVY INDUSTRIES, LTD., Tokyo (JP)

(21) Appl. No.: 18/042,095

(22) PCT Filed: Sep. 28, 2021
(86) PCT No.: PCT/JP2021/035624

§ 371 Date: Feb. 17, 2023

(30) Foreign Application Priority Data
Oct. 2, 2020 (JP) 2020-168020

(51) Int. Cl. F16F 15/08

(52) U.S. Cl. CPC F16F 15/08; F16F 2230/007

(57) ABSTRACT

An anti-vibration mount for supporting a load of a part includes: at least one mount body that includes a central projecting portion having a load acting surface on which the load of the part acts, and a seat portion which includes a one-side seat portion located on one side with respect to the central projecting portion in a cross section along an action direction of the load, the one-side seat portion having a one-side reaction force receiving surface for receiving a reaction force from a base surface, and an another-side seat portion located on another side opposite to the one side with respect to the central projecting portion across the central projecting portion in the cross section, the another-side seat portion having an another-side reaction force receiving surface for receiving the reaction force from the base surface.

### TECHNICAL FIELD

The present disclosure relates to an anti-vibration mount.

This application claims the priority of Japanese Patent Application No. 2020-168020 filed on Oct. 2, 2020, the content of which is incorporated herein by reference.

### BACKGROUND

An anti-vibration mount is used in a vehicle, an industrial machine, or the like in order to prevent vibration of a part. In general, in order to increase an anti-vibration effect on the anti-vibration mount, it is known that lowering the rigidity of the anti-vibration mount and lowering the natural frequency of a member (vibration system) including the part and the anti-vibration mount are effective. However, if an anti-vibration mount with a small spring constant is used, the amount of displacement of the anti-vibration mount increases, making it difficult to satisfy a constraint on the amount of displacement if this constraint is defined for the part. Conventionally, due to this constraint, a lower limit value of the achievable natural frequency remains at about 5 Hz.

Patent Document 1 discloses an anti-vibration member for suppressing vibration transmission from a fixed surface such as a vehicle body to information equipment such as a personal computer mounted on a vehicle or the like. Patent Document 1 gives, as anti-vibration characteristics for avoiding occurrence of large vibration, a low response magnification during resonance and a low resonance frequency. Therefore, the anti-vibration member disclosed in Patent Document 1 has a structure in which the response magnification during resonance and the resonance frequency are lowered while preventing buckling. Patent Document 2 discloses an impact energy absorber used for an automobile door trim. Patent Document 2 describes that this energy absorber includes a lattice-like absorber body composed of an elastic material, and when a load exceeding an elastic limit is applied, the energy absorber exhibits specific compression and buckling characteristics, thereby being able to absorb the impact energy without causing breakage.

### CITATION LIST

### Patent Literature

Patent Document 1: JP2008-175332A
Patent Document 2: JPH07-228144A

### SUMMARY

### Technical Problem

Although the anti-vibration member disclosed in Patent Document 1 has the structure in which the resonance frequency is lowered, the structure is for suppressing the occurrence of buckling, and thus the lower limit value of the resonance frequency is not decreased. Therefore, the anti-vibration effect is also limited. The energy absorber disclosed in Patent Document 2 utilizes buckling of a structural material to avoid breakage and is aims at absorbing impact energy, and thus an elastic material having a high elastic modulus is used for the structural material. Therefore, not much anti-vibration effect can be expected.

The present disclosure has been made in view of the above, and an object of the present disclosure is to reduce the natural frequency of the member including the part and the anti-vibration mount while satisfying the constraint on the amount of displacement of the part, thereby further improving the anti-vibration effect.

### Solution to Problem

In order to achieve the above object, an anti-vibration mount according to the present disclosure is an anti-vibration mount for supporting a load of a part, including at least one mount body that includes a central projecting portion having a load acting surface on which the load of the part acts; a seat portion which includes a one-side seat portion located on one side with respect to the central projecting portion in a cross section along an action direction of the load, the one-side seat portion having a one-side reaction force receiving surface for receiving a reaction force from a base surface, and an another-side seat portion located on another side opposite to the one side with respect to the central projecting portion across the central projecting portion in the cross section, the another-side seat portion having an another-side reaction force receiving surface for receiving the reaction force from the base surface; and a connection portion which includes a one-side connection portion extending from the one-side seat portion toward the central projecting portion in the cross section, and an another-side connection portion extending from the another-side seat portion toward the central projecting portion in the cross section.

### Advantageous Effects

With an anti-vibration amount according to the present disclosure, by focusing on buckling distortion, it is possible to reduce the natural frequency of a member (vibration system) including a part and the anti-vibration mount in the vicinity of a load rating of the part, while satisfying a constraint on the amount of displacement of the part. Thus, the natural frequency of the vibration system including the part and the anti-vibration mount can be reduced to a low frequency range that could not be realized conventionally, making it possible to improve the anti-vibration effect.

### BRIEF DESCRIPTION OF DRAWINGS

FIG. 1 is a schematic front view of an anti-vibration mount according to an embodiment.

FIG. 2 is a perspective view of a mount body according to an embodiment.

FIG. 3 is a cross-sectional view taken along line A-A in FIG. 2.

FIG. 4 is a graph showing load-displacement characteristics of the anti-vibration mount according to an embodiment.

FIG. 5 is a plan view of the mount body according to an embodiment.

FIG. 6 is a cross-sectional view taken along line B-B in FIG. 5.

FIG. 7 is a cross-sectional view of the mount body according to an embodiment.

FIG. 8 is a cross-sectional view of the mount body according to an embodiment.

FIG. 9 is a chart showing a vibration generation status in the anti-vibration mount.

FIG. 10 is a perspective view of the partially cut anti-vibration mount according to an embodiment.

FIG. 11 is a schematic front view of the anti-vibration mount according to an embodiment.

FIG. 12 is a schematic plan view of the anti-vibration mount according to an embodiment.

FIG. 13 is a schematic plan view of the anti-vibration mount according to an embodiment.

FIG. 14 is a graph showing load-displacement characteristics of a conventional anti-vibration mount.

### DETAILED DESCRIPTION

Some embodiments of the present invention will be described below with reference to the accompanying drawings. It is intended, however, that unless particularly specified, dimensions, materials, shapes, relative positions and the like of components described in the embodiments or shown in the drawings shall be interpreted as illustrative only and not intended to limit the scope of the present invention.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same”, “equal”, and “uniform” shall not be construed as indicating only the state in which the feature is strictly equal, but also includes a state in which there is a tolerance or a difference that can still achieve the same function.

Further, for instance, an expression of a shape such as a rectangular shape or a tubular shape shall not be construed as only the geometrically strict shape, but also includes a shape with unevenness or chamfered corners within the range in which the same effect can be achieved.

On the other hand, an expressions such as “comprising”, “including”, “having”, “containing”, and “constituting” one constitutional element are not intended to be exclusive of other constitutional elements.

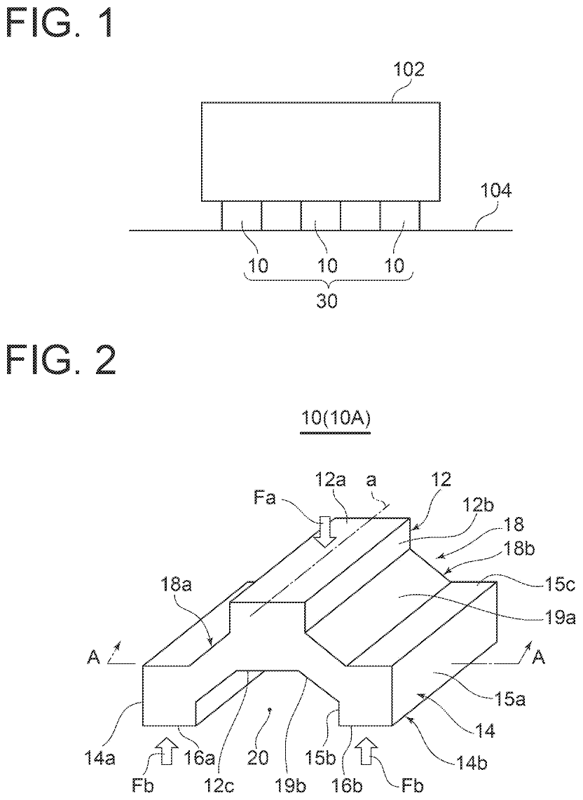

FIG. 1 is a schematic front view of an anti-vibration mount according to an embodiment, and shows a state where a part 102 is mounted on a base surface 104 via an anti-vibration mount 30. The part 102 is, for example, a vehicle engine, a compressor for a car air conditioner, a turbocharger, a ship engine, a ship auxiliary equipment (pump, etc.), or the like, and the base surface 104 is a support surface formed by a vehicle body on which the anti-vibration mount 30 is supported, a hull support portion, or the like. The part 102 and the anti-vibration mount 30 constitute one vibration system, and the vibration system has a vibration characteristic corresponding to the spring constant of the anti-vibration mount 30. The anti-vibration mount 30 includes at least one mount body 10.

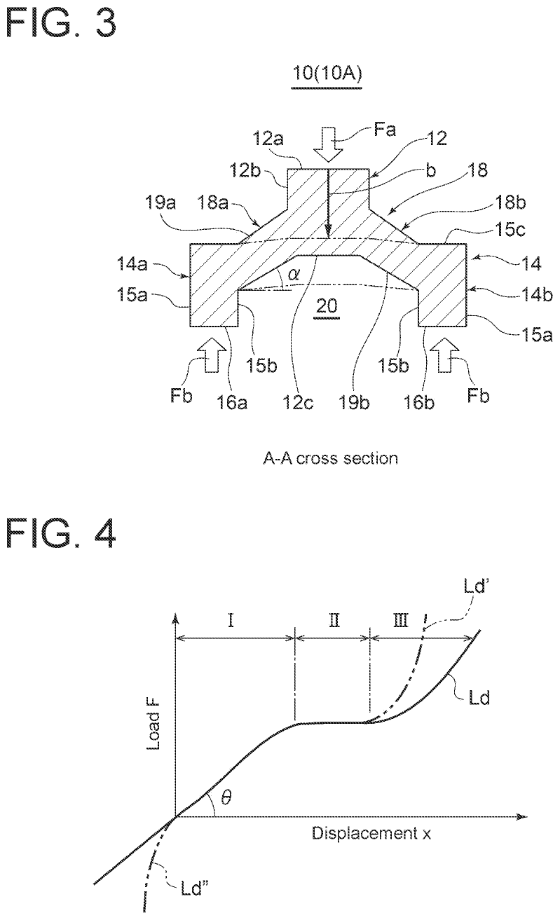

FIG. 2 is a perspective view of the mount body 10 (10A) according to an embodiment, and FIG. 3 is a cross-sectional view taken along line A-A in FIG. 2. In FIGS. 2 and 3, the mount body 10 (10A) includes a central projecting portion 12 disposed on one end side, a seat portion 14 disposed on another end side, and a connection portion 18 disposed between the central projecting portion 12 and the seat portion 14. The central projecting portion 12 has at an upper end a load acting surface 12a on which a load (a compressive load or a tensile load) Fa of the part 102 acts. The seat portion 14 includes a one-side seat portion 14a located on one side with respect to the central projecting portion 12 and an another-side seat portion 14b located on an opposite side (another side) to the one-side seat portion 14a across the central projecting portion 12. The one-side seat portion 14a has a one-side reaction force receiving surface 16a for receiving a reaction force Fb from the base surface 104, and the another-side seat portion 14b has an another-side reaction force receiving surface 16b for receiving the reaction force Fb from the base surface 104. The connection portion 18 includes a one-side connection portion 18a extending from the one-side seat portion 14a toward the central projecting portion 12, and an another-side connection portion 18b extending from the another-side seat portion 14b toward the central projecting portion 12.

In the exemplary embodiment shown in FIG. 2, the mount body 10 (10A) has a cross section extending along the direction of an axis a and having the same shape in any cross section along the direction of the axis a.

FIG. 4 is graph showing an example of a load-displacement curve Ld when the anti-vibration mount 30 including the mount body 10 (10A) receives the load Fa from the part 102. The anti-vibration mount 30 is displaced in proportion to the magnitude of the load up to a load of a certain magnitude, relative to the load Fa received from the part 102 (first region I). If the load Fa exceeds the certain magnitude, the connection portion 18 undergoes buckling distortion and decreases in rigidity, and thus the spring constant decreases in the vicinity of the load (second region II). FIG. 3 indicates, by double-dotted chain lines, a change in shape of the central projecting portion 12 and the connection portion 18 due to buckling distortion. A solid line indicates the shape of the connection portion 18 before buckling distortion, and the double-dotted chain lines indicate the shape of the connection portion 18 after buckling distortion. The central projecting portion 12 receives the compressive load Fa from the part 102, whereby the central projecting portion 12 and the connection portion 18 undergo buckling distortion in the direction of an arrow b, resulting in the shape indicated by the double-dotted chain lines. The length of the arrow b indicates the range of buckling distortion.

If the load Fa received from the part 102 further increases and deformation of the anti-vibration mount 30 progresses, the rigidity of the anti-vibration mount 30 increases again, causing displacement in proportion to the magnitude of the load relative to a high load, making it possible to receive a load exceeding assumption (third region III). By adjusting the spring constant of the mount body 10 (10A), it is possible to adjust a slope angle θ of the load-displacement curve Ld in the first region I and the third region III. Thus, it is possible to reduce the spring constant in the second region II while suppressing the amount of displacement of the part 102 in the first region I. Then, by setting the load rating of the part 102 in the second region II, the spring constant can be reduced in the vicinity of the load rating, and thus the natural frequency of the vibration system including the part 102 and the anti-vibration mount can be reduced to a low frequency range that could not be realized conventionally, making it possible to exert maximum anti-vibration effect.

In the load-displacement curve Ld shown in FIG. 4, the spring constant is almost zero due to buckling distortion in the second region II. Thus, the natural frequency of the vibration system including the part 102 and the anti-vibration mount 30 can be reduced to the maximum.

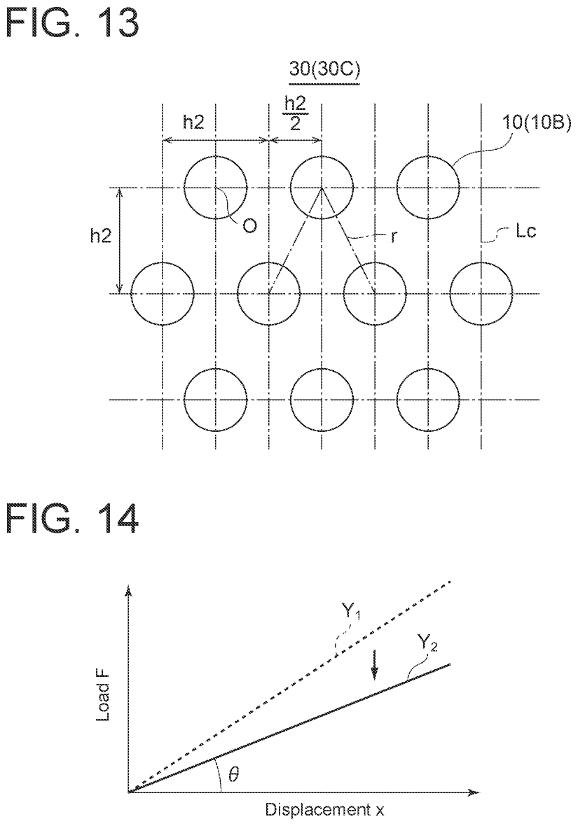

FIG. 14 is a graph showing load-displacement characteristics of a conventional anti-vibration mount. The conventional anti-vibration mount is used in a linear region where elastic deformation is performed in which a load F applied to the anti-vibration mount is proportional to displacement x of the anti-vibration mount, as indicated by load-displacement curves Y₁ and Y₂. The load-displacement curves Y₁ and Y₂ are each a straight line having the slope angle θ corresponding to the spring constant. Conventionally, in order to increase the anti-vibration effect of the anti-vibration mount, a material with the small slope angle θ (that is, the small spring constant) like the load-displacement curve Y₂ is used for the anti-vibration mount to lower the natural frequency of the vibration system including the anti-vibration mount and the part 102. In this case, the amount of displacement of the part 102 increases, and it becomes difficult to satisfy the constraint on the amount of displacement defined for the part 102. Due to the constraint on the amount of displacement, there is also a limit to the lower limit value of the natural frequency.

In an embodiment, as shown in FIG. 2, the one-side connection portion 18a extends obliquely with respect to an action direction of the load Fa from the one side toward the another side. Further, the another-side connection portion 18b extends obliquely with respect to the action direction of the load Fa, conversely from the another side toward the one side. In other words, the one-side connection portion 18a and the another-side connection portion 18b extend obliquely with respect to the action direction of the load Fa from the outside toward the central projecting portion 12 located on the center side. Thus, when the load Fa received from the part 102 exceeds a certain load and enters the second region II, the one-side connection portion 18a and the another-side connection portion 18b can reliably undergo buckling distortion.

As a comparative example, in a configuration where the connection portion 18 is inclined outward from the center side with respect to the action direction of the load Fa in the direction extending toward the central projecting portion 12, the anti-vibration mount 30 does not undergo buckling distortion in the second region II.

In the exemplary embodiments shown in FIGS. 2 and 3, the central projecting portion 12 of the mount body 10 (10A) is composed of a rectangular parallelepiped having the load acting surface 12a perpendicular to the action direction of the load Fa, both side surfaces 12b along the action direction of the load Fa, and a bottom surface 12c. The seat portion 14 is composed of a rectangular parallelepiped having the reaction force receiving surface 16a or 16b perpendicular to the reaction force Fb acting from the base surface 104, an outer surface and an inner surface 15b along the action direction of the reaction force Fb, and an upper surface 15c parallel to the reaction force receiving surface 16a or 16b. The one-side connection portion 18a and the another-side connection portion 18b of the connection portion 18, respectively, have inclined wall portions disposed obliquely with respect to the action direction of the load Fa in a direction approaching each other toward the central projecting portion 12. Each of the inclined wall portions has an upper inclined surface 19a and a lower inclined surface 19b, integrally connected at an upper end to a lower part of each of the both side surfaces 12b of the central projecting portion 12, and integrally connected at a lower end to an upper part of the inner surface 15b of the seat portion 14. An upper end of the mount body 10 (10A) is the load acting surface 12a of the central projecting portion 12, and the outer surfaces 15a of the one-side seat portion 14a and the another-side seat portion 14b are located at outer ends of the mount body 10 (10A) in the horizontal direction. Therefore, when the plurality of mount bodies 10 (10A) are arranged side by side without spacing, the outer surface of the one-side seat portion 14a and the outer surface 15a of the another-side seat portion 14b are arranged in contact with each other.

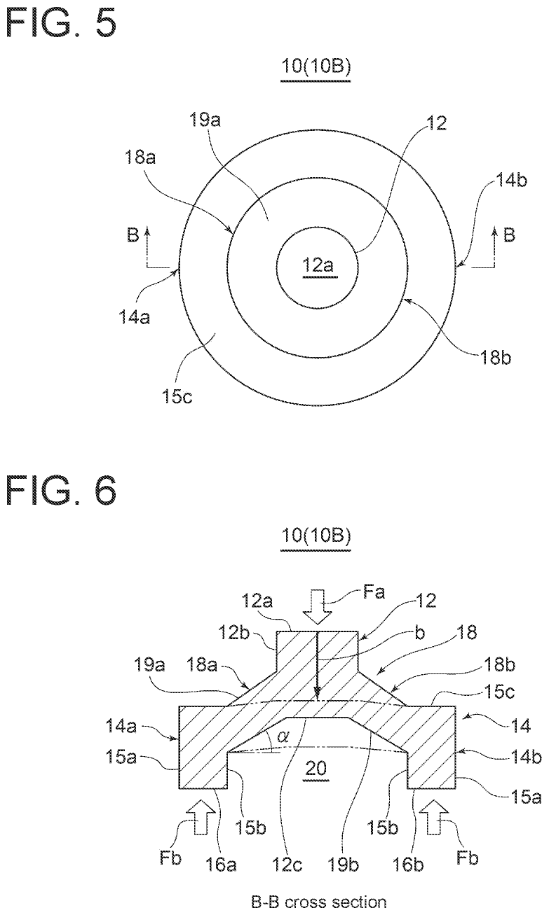

FIG. 5 is a plan view of the mount body 10 (10B) according to another embodiment, and FIG. 6 is a cross-sectional view taken along line B-B in FIG. 5. The mount body 10 (10B) includes the central projecting portion 12, the seat portion 14 formed into a circumferential shape around the central projecting portion 12, and the conical connection portion 18 shape disposed between the central projecting portion 12 and the seat portion 14. As shown in FIG. 6, the conical connection portion 18 includes the one-side connection portion 18a and the another-side connection portion 18b extending obliquely with respect to the action direction of the load Fa from the outside toward the central projecting portion 12 located on the center side. The anti-vibration mount 30 including the mount body 10 (10B) has the load-displacement characteristics shown in FIG. 4, as with the anti-vibration mount 30 including the mount body 10 (10A). Therefore, as with the anti-vibration mount 30 including the mount body 10 (10A), it is possible to improve the anti-vibration effect relative to the conventional anti-vibration mount.

Further, the mount body 10 (10B) has a three-dimensional structure in which any cross section along the action direction of the load Fa applied from the part 102 has the same cross section. Therefore, in the direction orthogonal to the direction in which the load Fa of the part 102 acts, the spring constant is always constant in the circumferential direction of the seat portion 14. Thus, a stable anti-vibration effect can be exhibited for the part 102.

As shown in FIG. 6, the cross section of the mount body 10 (10B) along the action direction of the load Fa has basically the same configuration as the mount body 10 (10A) shown in FIG. 3, and thus the same portions of the mount body 10 (10B) and the mount body 10 (10A) are given the same reference signs. The central projecting portion 12 of the mount body 10 (10B) has a cylindrical shape, and has the circular load acting surface 12a and the circular bottom surface 12c. The connection portion 18 is integrally connected to a lower part of a side surface of the central projecting portion 12, and is composed of a conical hollow wall portion having the upper inclined surface 19a and the lower inclined surface 19b. The seat portion 14 has the circular outer surface 15a and the circular inner surface 15b that are concentrically arranged. A lower end of the connection portion 18 is integrally connected to the upper part of the inner surface 15b of the seat portion 14.

As another embodiment, there is the anti-vibration mount that includes a mount body in which the connection portion 18 has a pyramidal shape and the outer surface 15a and the inner surface 15b of the seat portion 14 each have a rectangular shape. In the mount body of the present embodiment, the spring constant in the circumferential direction of the seat portion 14 is anisotropic in a direction along the horizontal plane (the plane perpendicular to the action directions of the load Fa and the reaction force Fb).

In an embodiment, in the anti-vibration mount 30 including the plurality of mount bodies 10 (10B), the heights of the central projecting portions 12 of the respective mount bodies (10B) are made different. Consequently, a time difference is added to an action start time of the load Fa acting on the respective central projecting portions 12. By appropriately adjusting the time difference, it is possible to appropriately adjust the slope angle θ of elastic deformation in the first region I.

In FIGS. 3 and 6, when an inclination angle α of the connection portion 18 with respect to the base surface 104 is in the range of 0°<α≤90°, the connection portion 18 can undergo buckling distortion. Therefore, the angle of the inclination angle α is decided within the range of 0°<α≤90° in consideration of, for example, the spring constant set in the first region I.

In an embodiment, a lower recess portion 20 formed between the one-side seat portion 14a and the another-side seat portion 14b is filled with a material having lower rigidity than the mount body 10. A low-rigidity material 32 filled in the lower recess portion 20 of the anti-vibration mount 30 (30A) shown in FIG. 10 which will be described later corresponds to the low-rigidity material. In the present embodiment, the elasticity of the low-rigidity material acts on the part 102 in the second region II, and thus the spring constant of the anti-vibration mount 30 is not zero but is a minute spring constant in the second region II. That is, in the second region II, the load-displacement curve Ld is slightly inclined. Thus, the anti-vibration mount 30 can stably support the part 102 in the second region II.

For example, the mount body 10 is composed of hard rubber, a resin material, a metal material, or the like, and the low-rigidity material filled in the lower recess portion 20 is constituted by a material having a lower rigidity than the mount body 10, such as soft rubber, foam material (for example, polyurethane foam). Herein, the level of “rigidity” is decided by the magnitude of the elastic modulus (E=stress σ/strain ε), and the higher the elastic modulus, the higher the rigidity, and the lower the elastic modulus, the lower the rigidity.

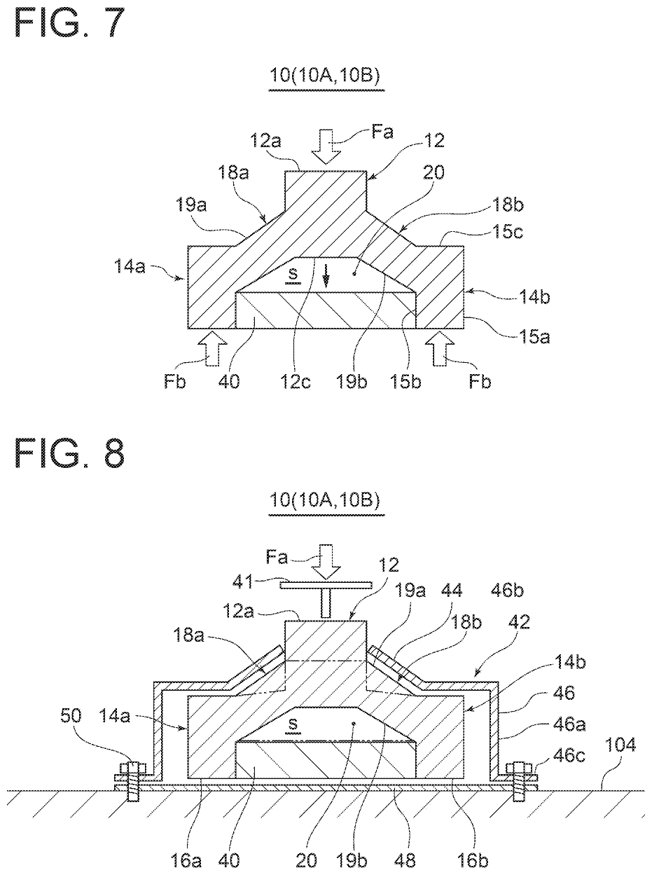

If the base surface 104 side vibrates, for example, if the part 102 is mounted on a vibrating vehicle body such as a vehicle, the vibration on the base surface 104 side may increase the vibration displacement of the part 102. The embodiment of the mount body 10 for coping with the above will be described below. In an embodiment, as shown in FIG. 7, the lower recess portion 20 is provided with a first stopper 40, and a gap s is formed between the central projecting portion 12 and the first stopper 40. According to the present embodiment, the first stopper 40 receives the displacement of the central projecting portion 12 due to the compressive load Fa applied from the part 102, making it possible to reduce the amount of elastic deformation of the anti-vibration mount 30 in the third region III after buckling distortion. That is, it is possible to increase the slope angle θ of the third region III in FIG. 4. In FIG. 4, a line Ld′ indicates a load-displacement curve when the first stopper 40 is provided.

Thus, since the first stopper 40 is provided, it is possible to suppress elastic displacement of the anti-vibration mount 30 in the third region III. Therefore, it is possible to suppress vibration displacement of the part 102 above a certain level. Further, by adjusting the rigidity of the first stopper 40, it is possible to adjust the amount of elastic deformation of the anti-vibration mount 30 in the third region III.

FIG. 7 is a cross-sectional view taken along the same cross section as FIG. 3 or FIG. 6. In the exemplary embodiment shown in FIG. 7, the first stopper 40 is composed of a rectangular parallelepiped with long sides extending in the direction of the axis a if the first stopper 40 is applied to the mount body 10 (10A), and the first stopper 40 is composed of a cylindrical body if the first stopper 40 is applied to the mount body 10 (10B). The first stopper may be produced separately from the mount body 10 or may be produced integrally with the mount body 10.

In an embodiment, the first stopper 40 is formed separately from the mount body 10 and is composed of a material having higher rigidity than the mount body 10. Thus, it is possible to suppress elastic displacement of the anti-vibration mount 30 in the third region III, and it is possible to suppress vibration displacement of the part 102 above the certain level. The first stopper 40 is composed of, for example, hard rubber, a resin material, or a metal material having higher rigidity than the first stopper 40.

In the exemplary embodiment shown in FIG. 7, a lower surface of the first stopper 40 is flush with the reaction force receiving surface 16b of the seat portion 14. Thus, the mount body 10 is easily mounted on the base surface 104.

In an embodiment, as shown in FIG. 8, a second stopper 42 is provided. When the anti-vibration mount 30 receives the tensile load from the part 102, the second stopper 42 can suppress displacement of the central projecting portion 12 toward the part 102 due to vibration of the base surface 104. Further, by increasing the rigidity of the second stopper 42, the displacement of the central projecting portion 12 toward the part 102 due to the vibration of the base surface 104 can be suppressed to not greater than a certain value. As with FIG. 7, FIG. 8 is a cross-sectional view taken along the same cross section as FIG. 3 or FIG. 6. The second stopper 42 has a shape extending in the direction of the axis a if the second stopper 42 is applied to the mount body 10 (10A), and the second stopper 42 has a circular shape if the second stopper 42 is applied to the mount body 10 (10B).

In the exemplary embodiment shown in FIG. 8, the second stopper 42 has a casing-like configuration surrounding the mount body 10, except for the load acting surface 12a.

In FIG. 4, Ld″ indicates a load-displacement curve when the central projecting portion 12 receives the tensile load from the part 102, and in this case as well, the slope angle θ increases.

In the exemplary embodiment shown in FIG. 8, the second stopper 42 includes a stopper portion 44 spaced apart from the connection portion 18, and a support portion 46 for supporting the stopper portion 44. That is, the stopper portion 44 is arranged parallel to and apart from the upper inclined surface 19a of the connection portion 18 arranged obliquely with respect to the action direction of the load Fa. In the exemplary embodiment, the connection portion 18 hits the stopper portion 44 if the vibration of the connection portion 18 caused by the vibration of the base surface 104 reaches or exceeds a certain amount, restricting the displacement of the anti-vibration mount 30. Further, since the stopper portion 44 is spaced apart from the connection portion 18, it is possible to prevent the vibration on the base surface 104 side from being transmitted to the connection portion 18 via the second stopper 42, and further from being transmitted from the connection portion 18 to the part 102.

In another embodiment, the stopper portion 44 is arranged at a position facing the central projecting portion 12, facing the load acting surface 12a of the central projecting portion 12, and spaced apart from the load acting surface 12a. For example, the stopper portion 44 is arranged along a direction orthogonal to the action direction of the load Fa. Consequently, the load acting surface 12a hits the stopper portion 44 if the vibration of the connection portion 18 caused by the vibration of the base surface 104 reaches or exceeds the certain amount, restricting the displacement of the anti-vibration mount 30. Further, in the present embodiment, since the stopper portion 44 is spaced apart from the central projecting portion 12, it is possible to prevent the vibration on the base surface 104 side from being transmitted to the connection portion 18 via the second stopper 42, and further from being transmitted from the connection portion 18 to the part 102.

Further, in the exemplary embodiment shown in FIG. 8, the mount body 10 and the second stopper 42 are fixed to a support plate 48, and the support plate 48 is fixed to the base surface 104. The second stopper 42 includes a flange 46c, and the second stopper 42 is attached to the base surface 104 with a bolt 50 along with an end of the support plate 48 via the flange 46c. Further, the reaction force receiving surfaces 16a and 16b of the seat portion 14 are fixed to an upper surface of the support plate 48 with an adhesive agent or the like. By thus mounting the mount body 10 on the base surface 104 via the support plate 48, the anti-vibration mount 30 can stably be mounted on the base surface 104.

In the exemplary embodiment shown in FIG. 8, the support portion 46 includes a cylindrical wall 46a mounted perpendicular to the support plate 48, and an annular partition wall 46b connected perpendicularly to the cylindrical wall 46a. The stopper portion 44 is composed of a conical partition wall connected to a center side of the annular wall 46b, and an opening into which the central projecting portion 12 is inserted is formed at the center of the stopper portion 44b. In FIG. 8, 41 denotes a spacer for preventing the part 102 from interfering with the stopper portion 44 when the mount body 10 receives the compressive load Fa from the part 102 and is deformed in the compression direction.

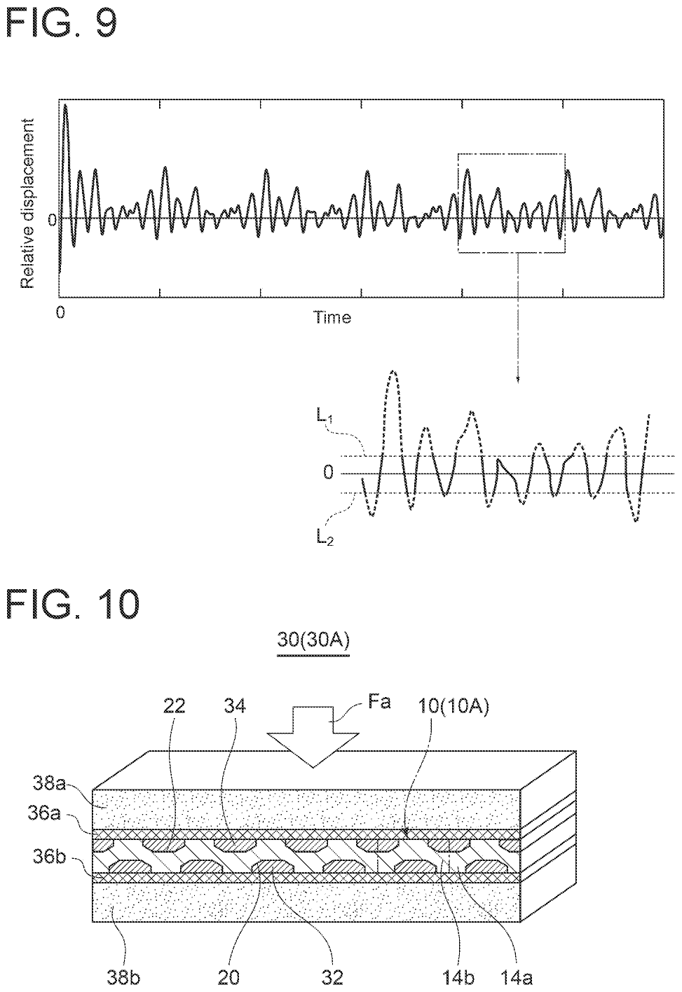

FIG. 9 shows an example of relative displacement between the base surface 104 and the part 102 when the part 102 is mounted on the base surface 104 via the mount body 10 and the base surface 104 vibrates. In FIG. 10, a line L₁ indicates a regulation amount of the above-described relative displacement when the first stopper 40 is provided, and a line L2 indicates a regulation amount of the above-described relative displacement when the second stopper 42 is provided. As shown in FIG. 9, since the first stopper 40 and the second stopper 42 are provided, the relative displacement between the base surface 104 and the part 102 can be regulated within an allowable range.

In an embodiment, as shown in FIG. 1, the plurality of mount bodies 10 are arranged side by side with each other. Thus, the anti-vibration mount 30 can form a wide anti-vibration surface capable of supporting the large part 102.

In an embodiment, when the plurality of mount bodies 10 are arranged side by side with each other, the respective seat portions 14 of the plurality of mount bodies 10 are arranged to contact each other. Thus, it is possible to increase load bearing strength per unit area of the anti-vibration surface for supporting the part 102.

FIG. 10 is a perspective view showing the anti-vibration mount 30 (30A) according to an embodiment, which includes the mount body 10 (10A). The anti-vibration mount 30 (30A) includes the plurality of mount bodies 10 (10A) arranged side by side along the base surface 104 (not shown). Further, an upper support layer 36a is arranged on the load acting surface 12a formed by the upper surface of each of the central projecting portions 12 of the plurality of mount bodies 10 (10A), and the upper support layer 36a is supported by the plurality of load acting surfaces 12a. The load Fa of the part 102 is transmitted to the load acting surfaces 12a of the plurality of mount bodies 10 (10A) via the upper support layer 36a. Since the load Fa of the part 102 is thus transmitted to the load acting surface 12a of each mount body (10A) via the upper support layer 36a, even if the anti-vibration mount 30 (30A) forms the wide anti-vibration surface, the load Fa of the part 102 is evenly transmitted to the plurality of mount bodies 10 (10A).

In the exemplary embodiment, the anti-vibration mount 30 (30A) includes the lower recess portion 20 filled with the above-described low-rigidity material 32.

In an embodiment, the upper support layer 36a has higher rigidity than the mount body 10 (10A). The load Fa of the part 102 is transmitted to the load acting surface 12a of each of the plurality of mount bodies 10 (10A) via the upper support layer 36a having high rigidity, and thus evenly transmitted to each load acting surface 12a. Accordingly, it is possible to enhance the anti-vibration effect on the part 102.

For example, the upper support layer 36a is composed of hard rubber, a resin material, a metal material, or the like having higher rigidity than the mount body 10 (10A).

In an embodiment, as shown in FIG. 10, one lower support layer 36b is disposed so as to support the one-side reaction force receiving surface 16a and the another-side reaction force receiving surface 16b of each of the plurality of mount bodies 10 (10A). Consequently, the load of the mount bodies 10 (10A) is evenly transmitted to the base surface 104 via the lower support layer 36b, making it possible to enhance the anti-vibration effect on the part 102.

In an embodiment, the lower support layer 36b has higher rigidity than the mount body 10 (10A). For example, the lower support layer 36b is composed of the same material as the upper support layer 36a. Thus, the load of the mount body 10 (10A) is more evenly transmitted to the base surface 104 via the lower support layer 36b, making it possible to further enhance the anti-vibration effect on the part 102.

In an embodiment, as shown in FIG. 10, an upper elastic layer 38a having lower rigidity than the mount body 10 (10A) is further provided outside the upper support layer 36a. When it is difficult to adjust the load-displacement characteristics for performing elastic deformation in the first region I and the third region III only with the mount body 10 (10A), the upper elastic layer 38a is provided to adjust quality of the material, shape, and the like of the upper elastic layer 38a, facilitating adjustment of the elastic deformation amounts in the first region I and the third region III.

In an embodiment, as shown in FIG. 10, a lower elastic layer 38b having lower rigidity than the mount body 10 (10A) is provided outside the lower support layer 36b. When it is difficult to adjust the load-displacement characteristics for performing elastic deformation in the first region I and the third region III only with the mount body 10 (10A) or the upper elastic layer 38a, the lower elastic layer 38b is provided to adjust quality of the material, shape, and the like of the lower elastic layer 38b, facilitating adjustment of the elastic deformation amounts in the first region I and the third region III.

In an embodiment, as with the anti-vibration mount 30 (30A) shown in FIG. 10, in the plurality of mount bodies 10 (10A) arranged side by side with each other, the one-side seat portion 14a of the one-side mount body and the another-side seat portion 14b of the another-side mount body are formed integrally with each other. Thus, the plurality of mount bodies (10A) arranged side by side can be produced in one process, facilitating production of the anti-vibration mount 30 (30A).

If the plurality of mount bodies 10 are arranged side by side as in the anti-vibration mount 30 (30A) shown in FIG. 10, an upper recess portion 22 is formed between the central projecting portions 12 of the respective mount bodies 10. In an embodiment, the upper recess portion 22 is filled with a low-rigidity material 34 having lower rigidity than the mount body 10. Consequently, the elasticity of the low-rigidity material 34 acts on the part 102 in the second region II, making it possible to increase the spring constant of the anti-vibration mount 30 (30A). Thus, the anti-vibration mount 30 (30A) can stably support the part 102 in the second region II. The low-rigidity material 34 is composed of, for example, the same material as the above-described low-rigidity material 32.

In the anti-vibration mount 30 (30A) shown in FIG. 10, the lower recess portion 20 or the upper recess portion 22 may be covered with the upper support layer 36a or the upper support layer 36a to form a closed space without filling the lower recess portion 20 or the upper recess portion 22 with the low-rigidity material 32 or 34, and a gas such as air may be enclosed in the closed space. Thus, the enclosed gas can play the same role as the low-rigidity material 32 or 34.

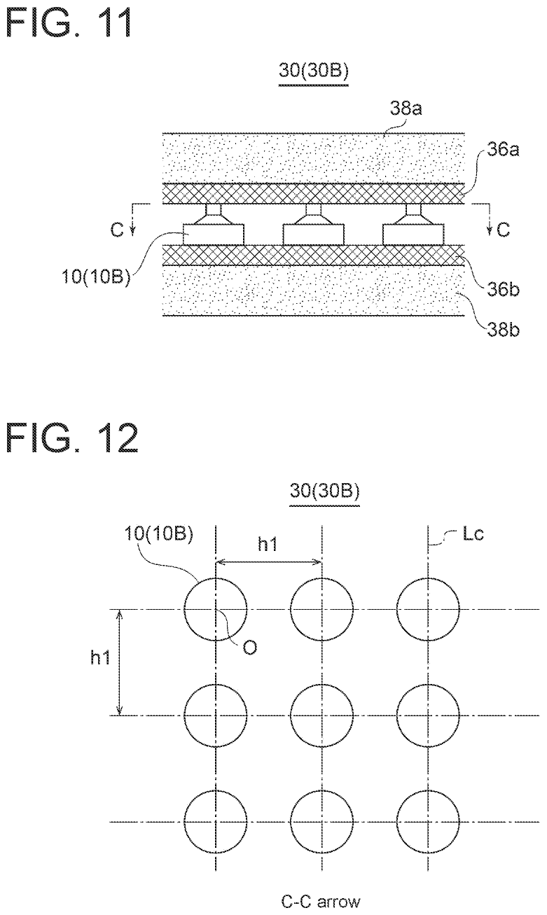

FIG. 11 is a front view showing the anti-vibration mount 30 (30B) according to an embodiment, which includes the plurality of mount bodies 10 (10B), and FIG. 12 is a schematic view of the anti-vibration mount 30 (30B) viewed from above along line C-C. FIG. 13 shows the anti-vibration mount 30 (30C) according to another embodiment, which includes the plurality of mount bodies 10 (10B), and is a schematic view of the anti-vibration mount 30 (30C) viewed from above. In the present embodiments, between the adjacent mount bodies 10 (10B), the one-side seat portion 14a of the one-side mount body and the another-side seat portion 14b of the another-side mount body are arranged side by side at intervals. Thus, it is possible to adjust the load bearing strength per unit area of the anti-vibration surface for supporting the part 102, by adjusting the intervals formed between the seat portions 14 among the respective mount bodies.

FIG. 12 is an arrow view (schematic plan view) taken along line C-C in FIG. 11. The anti-vibration mount 30 (30B) includes the plurality of mount bodies 10 (10B) arranged in an orthogonal grid pattern in plan view. FIG. 13 is a plan view corresponding to FIG. 12 of the anti-vibration mount 30 (30C). The anti-vibration mount 30 (30C) shown in FIG. 13 includes the plurality of mount bodies 10 (10B) arranged in a staggered grid pattern in plan view. In FIG. 12, an intervals h1 between center lines Lc passing through centers O of the central projecting portions 12 of the respective mount bodies 10 (10B) are equal. In FIG. 13, as intervals between the center lines Lc passing through the centers O of the central projecting portions 12, an interval in one direction is denoted by h2, whereas an interval in a direction orthogonal to the one direction is set to ½ of h2. Therefore, a line r connecting the centers O of the three adjacent central projecting portions 12 forms an equilateral triangle. Since the respective central projecting portions 12 are thus uniformly distributed and arranged, the load Fa of the part 102 is uniformly applied to the plurality of load acting surfaces 12a.

As shown in FIGS. 10 to 13, the plurality of mount bodies 10 (10A, 10B) are arranged such that each of the plurality of central projecting portions 12 faces the same direction in the action direction of the load Fa, and the seat portions 14 are arranged facing the same direction. That is, the central projecting portion 12 of each of the plurality of mount bodies is arranged on the part 102 side, and the seat portion 14 is arranged on the base surface 104 side.

If the above-described anti-vibration mount 30 is minimally provided with the mount body 10, it is possible to obtain the load-displacement characteristics having three stages of the first region I to the third region III shown in FIG. 4. That is, it is possible to obtain the load-displacement characteristics in the first region I and the third region III by elastic deformation of the central projecting portion 12 and the seat portion 14 whose material or shape are appropriately selected. For example, by forming a slit in the central projecting portion 12 or the seat portion 14, elastic deformation with a large amount of deformation can occur in the central projecting portion 12 or the seat portion 14.

The contents described in the above embodiments would be understood as follows, for instance.

1) An anti-vibration mount according one aspect is an anti-vibration mount (30) for supporting a load (Fa) of a part (102), including at least one mount body (10) that includes a central projecting portion (12) having a load acting surface (12a) on which the load (Fa) of the part (102) acts; a seat portion (14) which includes a one-side seat portion (14a) located on one side with respect to the central projecting portion (12) in a cross section along an action direction of the load (Fa), the one-side seat portion having a one-side reaction force receiving surface (16a) for receiving a reaction force (Fb) from a base surface (104), and an another-side seat portion (14b) located on another side opposite to the one side with respect to the central projecting portion (12) across the central projecting portion (12) in the cross section, the another-side seat portion having an another-side reaction force receiving surface (16b) for receiving the reaction force (Fb) from the base surface (104); and a connection portion (18) which includes a one-side connection portion (18a) extending from the one-side seat portion (14a) toward the central projecting portion (12) in the cross section, and an another-side connection portion (18b) extending from the another-side seat portion (14b) toward the central projecting portion (12) in the cross section.

With such configuration, the anti-vibration mount (30) has load-displacement characteristics that include a first region (I) where the anti-vibration mount (30) is elastically displaced in proportion to the magnitude of the load up to the load of the certain magnitude, relative to the load (Fa) received from the part (102), a second region (II) where, if the load (Fa) exceeds the load of the certain magnitude, the above-described connection portion (18) undergoes buckling distortion and decreases in rigidity and the spring constant decreases in the vicinity of the load compared to the first region (I), and a third region (III) where if the compressive load (Fa) received from the part (102) further increases, the rigidity of the anti-vibration mount increases again, causing elastic displacement. Thus, it is possible to reduce the spring constant in the second region (II) while suppressing the amount of displacement of the part (102) in the first region (I). Then, by setting the load rating of the part (102) in the second region (II), the spring constant can be reduced in the vicinity of the load rating, and thus the natural frequency of the vibration system including the part (102) and the anti-vibration mount (30) can be reduced to a low frequency range that could not be realized conventionally, making it possible to exert maximum anti-vibration effect.

2) An anti-vibration mount according to another aspect is the anti-vibration mount as defined in 1), wherein the one-side connection portion (18a) extends obliquely with respect to the action direction of the load (Fa) from the one side toward the another side, and wherein the another-side connection portion (18b) extends obliquely with respect to the action direction of the load (Fa) from the another side toward the one side.

With such configuration, the connection portion (18) can correctly undergo buckling distortion in the above-described second region (II).

3) An anti-vibration mount according to still another aspect is the anti-vibration mount as defined in 1) or 2), wherein a lower recess portion (20) formed between the one-side seat portion (14a) and the another-side seat portion (14b) is filled with a material (32) having lower rigidity than the mount body (10).

With such configuration, the elasticity of the low-rigidity material acts on the compressive load (Fa) applied from the part (102) in the second region (II) if the above-described lower recess portion (20) is filled with the low-rigidity material (32), making it possible to increase the spring constant of the anti-vibration mount (30). The anti-vibration mount (30) can stably support the part (102) in the second region (II).

4) An anti-vibration mount according to yet another aspect is the anti-vibration mount as defined in 3), wherein the anti-vibration mount further includes a first stopper (40) disposed in the lower recess portion (20), and wherein a gap is formed between the central projecting portion (12) and the first stopper (40).

For example, if the part (102) is mounted on a vehicle body of a vehicle, the vibration on the base surface (104) side may increase the vibration of the part (102). By contrast, with the above configuration, since the displacement of the central projecting portion (12) can be restricted by the above-described first stopper (40), it is possible to suppress the vibration displacement of the part (102) above a certain level. Further, by adjusting the rigidity of the first stopper (40), it is possible to adjust the elastic displacement in the third region (III).

5) An anti-vibration mount according to yet another aspect is the anti-vibration mount as defined in 4), wherein the first stopper (40) is formed separately from the mount body (10) and is composed of a material having higher rigidity than the mount body (10).

With the above configuration, thanks to high rigidity of the first stopper (40), it is possible to suppress vibration displacement of the part (102) above the certain level in the third region (III).

6) An anti-vibration mount according to yet another aspect is the anti-vibration mount as defined in any one of 1) to 5), wherein the anti-vibration mount (30) further includes a second stopper (42) for regulating displacement of the central projecting portion (12) toward the part (102) due to vibration of the base surface (104).

With such configuration, since the above-described second stopper (42) is provided, the displacement of the central projecting portion (12) toward the part (102) due to the vibration on the base surface (104) side can be suppressed to not greater than a certain value.

7) An anti-vibration mount according to yet another aspect is the anti-vibration mount as defined in 6), wherein the second stopper (42) includes a stopper portion (44) spaced apart from the central projecting portion (12) or the connection portion (18), and a support portion (46) for supporting the stopper portion (44).

With such configuration, since the above-described stopper portion (44) of the second stopper (42) is spaced apart from the central projecting portion (12) or the connection portion (18), it is possible to prevent the vibration on the base surface (104) side from being transmitted to the central projecting portion (12) or the connection portion (18) via the second stopper (42), and further from being transmitted from the central projecting portion (12) or the connection portion (18) to the part (102).

8) An anti-vibration mount according to yet another aspect is the anti-vibration mount as defined in any one of 1) to 7), wherein the at least one mount body (10) includes a plurality of mount bodies arranged side by side with each other.

With such configuration, it is possible to form the anti-vibration mount (30) having a wide anti-vibration surface for supporting the part (102). Thus, it is possible to form the anti-vibration surface capable of supporting a large part.

9) An anti-vibration mount according to yet another aspect is the anti-vibration mount as defined in 8), wherein the anti-vibration mount (30) further includes an upper support layer (36a) arranged to be supported on the load acting surface (12a) of each of the plurality of mount bodies (10).

With such configuration, since the load (Fa) of the part (102) is transmitted to the load acting surface of each of the plurality of mount bodies (10) via the above-described upper support layer (36a), even if the anti-vibration mount (30) has the wide anti-vibration surface, the load (Fa) of the part (102) can evenly be transmitted to the load acting surface of each of the plurality of mount bodies (10).

10) An anti-vibration mount according to yet another aspect is the anti-vibration mount as defined in 9), wherein the upper support layer (36a) has higher rigidity than the mount body.

With such configuration, since the upper support layer (36a) has higher rigidity than the mount body (10), the load (Fa) of the part (102) transmitted to the mount body (10) via the upper support layer (36a) is evenly transmitted to the load acting surface of each of the plurality of mount bodies (10).

11) An anti-vibration mount according to yet another aspect is the anti-vibration mount as defined in 9) or 10), wherein the anti-vibration mount (30) further includes an elastic layer (38a) disposed outside the upper support layer (36a) and having lower rigidity than the mount body.

With such configuration, since the above-described elastic layer (38a) is provided, the elastic deformation characteristics of the anti-vibration mount (30) in the first region (I) and the third region (III) can be adjusted to desired characteristics.

12) An anti-vibration mount according to yet another aspect is the anti-vibration mount as defined in any one of 8) to 11), wherein the plurality of mount bodies (10) include a first mount body and a second mount body arranged side by side with each other, and wherein the another-side seat portion (14b) of the first mount body and the one-side seat portion (14a) of the second mount body are formed integrally with each other.

With such configuration, the plurality of mount bodies (10) can be produced in one process, facilitating production of the anti-vibration mount (30).

13) An anti-vibration mount according to yet another aspect is the anti-vibration mount as defined in 12), wherein an upper recess portion (22) formed between the first mount body and the second mount body is filled with a low-rigidity material (34) having lower rigidity than the mount body (10).

With such configuration, since the above-described upper recess portion is filled with the above-described low-rigidity material (34), the elasticity of the low-rigidity material acts on the part in the second region (II), making it possible to increase the spring constant of the anti-vibration mount (30) in the second region (II). Thus, the anti-vibration mount (30) can stably support the part (102) in the second region (II).

14) An anti-vibration mount according to yet another aspect is the anti-vibration mount as defined in any one of 8) to 11), wherein the plurality of mount bodies (10) include a first mount body and a second mount body arranged side by side with each other, and wherein the another-side seat portion (14b) of the first mount body and the one-side seat portion (14a) of the second mount body are arranged at intervals from each other.

With such configuration, since the another-side seat portion (14b) of the first mount body and the one-side seat portion (14a) of the second mount body are arranged at intervals from each other, it is possible to adjust the load bearing strength per unit area of the anti-vibration surface for supporting the part (102), by adjusting the intervals.

15) An anti-vibration mount according to yet another aspect is the anti-vibration mount as defined in 14), wherein the mount body (10) includes the central projecting portion (12), and the seat portion (14) formed into a circumferential shape around the central projecting portion (12).

With such configuration, the mount body (10) has a three-dimensional structure in which any cross section along the action direction of the load (Fa) applied from the part (102) has the same cross section. Therefore, in the anti-vibration mount (30), the spring constant is always constant in the circumferential direction of the seat portion (14) in the direction orthogonal to the direction in which the load (Fa) of the part (102) acts, while achieving load-displacement characteristics from the first region (I) to the third region (III) in the direction in which the load (Fa) of the part (102) acts, making it possible to exert the stable anti-vibration effect on the part (102).

### REFERENCE SIGNS LIST

(10A, 10B) Mount body
12 Central projecting portion
12a Load acting surface
14 Seat portion
14a One-side seat portion
14b Another-side seat portion
15a Outer surface
15b Inner surface
15c Upper surface
16a One-side reaction force receiving surface
16b Another-side reaction force receiving surface
18 Connection portion
18a One-side connection portion
18b Another-side connection portion
19a Upper inclined surface
19b Lower inclined surface
19c Upper surface
20 Lower recess portion
22 Upper recess portion
30 (30A, 30B, 30C) Anti-vibration mount
32, 34 Low-rigidity material
36a Upper support layer
36b Lower support layer
38a Upper elastic layer
38b Lower elastic layer
40 First stopper
41 Spacer
42 Second stopper
44 Stopper portion
46 Support portion
46a Cylindrical wall
46b Annular wall
46c Flange
48 Support plate
50 Bolt
102 Part
104 Base surface
104 Lc Center line
O Center
Fa Load
Fb Reaction force
Ld, Ld′, Ld″, Y₁, Y₂ Load-displacement curve
a Axis
h1, h2 Interval
s Gap
θ Slope angle
I First region
II Second region
III Third region

1. An anti-vibration mount for supporting a load of a part, comprising at least one mount body that includes:
a central projecting portion having a load acting surface on which the load of the part acts;
a seat portion which includes
a one-side seat portion located on one side with respect to the central projecting portion in a cross section along an action direction of the load, the one-side seat portion having a one-side reaction force receiving surface for receiving a reaction force from a base surface, and
an another-side seat portion located on another side opposite to the one side with respect to the central projecting portion across the central projecting portion in the cross section, the another-side seat portion having an another-side reaction force receiving surface for receiving the reaction force from the base surface; and
a connection portion which includes
a one-side connection portion extending from the one-side seat portion toward the central projecting portion in the cross section, and
an another-side connection portion extending from the another-side seat portion toward the central projecting portion in the cross section,
wherein the one-side connection portion extends obliquely with respect to the action direction of the load from the one side toward the another side,
wherein the another-side connection portion extends obliquely with respect to the action direction of the load from the another side toward the one side,
wherein the anti-vibration mount further comprises a first stopper disposed in the lower recess portion, and
wherein a gap is formed between the central projecting portion and the first stopper.

2.-4. (canceled)

5. The anti-vibration mount according to claim 1, wherein the first stopper is formed separately from the mount body and is composed of a material having higher rigidity than the mount body.

6. The anti-vibration mount according to claim 1, wherein the anti-vibration mount further comprises a second stopper for regulating an amount of displacement of the central projecting portion toward the part due to vibration of the base surface.

7. The anti-vibration mount according to claim 6, wherein the second stopper includes a stopper portion spaced apart from the central projecting portion or the connection portion, and a support portion for supporting the stopper portion.

8. The anti-vibration mount according to claim 1, wherein the at least one mount body includes a plurality of mount bodies arranged side by side with each other.

9. The anti-vibration mount according to claim 8, wherein the anti-vibration mount further comprises an upper support layer arranged to be supported on the load acting surface of each of the plurality of mount bodies.

10. The anti-vibration mount according to claim 9, wherein the upper support layer has higher rigidity than the mount body.

11. The anti-vibration mount according to claim 9, wherein the anti-vibration mount further comprises an elastic layer disposed outside the upper support layer and having lower rigidity than the mount body.

12. The anti-vibration mount according to claim 8,
wherein the plurality of mount bodies include a first mount body and a second mount body arranged side by side with each other, and
wherein the another-side seat portion of the first mount body and the one-side seat portion of the second mount body are formed integrally with each other.

13. The anti-vibration mount according to claim 12, wherein an upper recess portion formed between the first mount body and the second mount body is filled with a low-rigidity material having lower rigidity than the mount body.

14. The anti-vibration mount according to claim 8,
wherein the plurality of mount bodies include a first mount body and a second mount body arranged side by side with each other, and
wherein the another-side seat portion of the first mount body and the one-side seat portion of the second mount body are arranged at intervals from each other.

15. The anti-vibration mount according to claim 14, wherein the mount body includes the central projecting portion, and the seat portion formed into a circumferential shape around the central projecting portion.
